(19) United States
(12) Patent Application Publication
(10) Pub. No.: US 2023/0037685 A1
(43) Pub. Date: Feb. 9, 2023

(54) METHOD AND APPARATUS FOR PROVIDING PLURALITY OF VIRTUAL NETWORKS FOR SINGLE APPLICATION IN MOBILE COMMUNICATION NETWORK

(71) Applicant: Samsung Electronics Co., Ltd., Gyeonggi-do (KR)

(72) Inventors: Yoonseon HAN, Gyeonggi-do (KR); Jicheol LEE, Gyeonggi-do (KR); Sangjun MOON, Gyeonggi-do (KR)

(21) Appl. No.: 17/791,107

(22) PCT Filed: Jan. 5, 2021
(86) PCT No.: PCT/KR2021/000066

§ 371 Date: Jul. 6, 2022

(30) Foreign Application Priority Data
Jan. 6, 2020 (KR) 10-2020-0001436

(51) Int. Cl. H04L 41/046; H04L 41/0893; H04L 12/46; H04L 67/14

(52) U.S. Cl. CPC H04L 41/046; H04L 41/0893; H04L 12/4641; H04L 67/14

(57) ABSTRACT

The present disclosure relates to a communication method and system for converging a 5^{th}-Generation (5G) communication system for supporting higher data rates beyond a 4^{th}-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. The support of a virtual network group according to an embodiment of the present disclosure enables efficient communication of a terminal by using an external network, configured via an existing short-range communication network, or a private network between terminals based on 5G. Accordingly, a network operator or an entity in charge thereof enables terminals to interwork with equipment through communication via a virtual private network without changes in an existing communication method or a network structure, or without adding additional equipment.

### TECHNICAL FIELD

The disclosure relates to a method of configuring a virtual network or a virtual local area network, which is an independent logical network configured with specific nodes in a mobile communication system. The nodes constituting the virtual network may be a terminal or a specific server positioned outside the mobile communication network, and data communication between them may be logically distinguished from other terminals or servers that do not constitute the virtual network or may have an independent route. Thereby, traffic generated within the virtual network may be closed and transmitted in isolation from other traffic. In order to support such a virtual network, a mobile communication network or a core network may use a method of managing information on terminals constituting a virtual network, a method of establishing and applying a policy related to a virtual network, a method of configuring a route for transmitting traffic of a virtual network, a method of distinguishing virtual network traffic on a route, and a connection method between terminals or servers constituting a virtual network positioned in an external network.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like.

In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

At the same time as the spread of 5G mobile communication begins, various wireless access technologies are mixed as in 3G or 4G (LTE) communication networks that have been used previously, and an available frequency band is expanded due to the introduction of a high frequency, and in order to satisfy the high communication requirements, more base stations than before are expected to be installed. In such a situation, in order to reduce the cost or power required for network management or to minimize interference, it is necessary to study a method of efficiently managing radio resources and devices.

### DISCLOSURE OF INVENTION

### Technical Problem

Various embodiments of the disclosure include a method of generating and managing a virtual network for transmitting traffic separated from other traffic between nodes constituting a specific group within a mobile communication system. A virtual network provided by the existing mobile communication network has a 1:1 relationship with a specific data network, and has a limitation that a single PDU session can be accessed only by a single virtual network. In order to overcome such a limitation, the method of the disclosure includes a method of accessing a plurality of virtual networks by a specific application by extending a method of providing an existing private network or virtual network and a method of transmitting a plurality of virtual network traffic in the same PDU session.

Technical problems to be achieved in the disclosure are not limited to the technical problems mentioned above, and other technical problems not mentioned may be clearly understood by those of ordinary skill in the art to which the disclosure belongs from the description below.

### Solution to Problem

In order to solve the above problems, in the disclosure, a method by a policy control function (PCF) in a wireless communication system includes receiving virtual network related information from an application function (AF); determining whether to support a plurality of virtual networks with the same data network name (DNN) based on the received virtual network related information; determining, in case that the plurality of virtual networks are supported with the same DNN, a DNN for the plurality of virtual networks; creating a user route selection policy (URSP) rule for the plurality of virtual networks; and transmitting the created URSP rule to a terminal constituting a virtual network.

In some embodiments, the method further includes transmitting, to unified data management (UDM), information on whether a plurality of virtual networks are merged. In another embodiment of the disclosure, a method by a terminal in a wireless communication system includes

receiving a user route selection policy (URSP) rule from a policy control function (PCF); transmitting a first message for a protocol data unit (PDU) session establishment request based on the USRP rule; and receiving information indicating that a PDU session has been established, wherein the USRP rule is created by the PCF.

In some embodiments, the information indicating that the PDU session has been established includes a quality of service (QoS) rule and a QoS flow with a virtual network group, and the first message further includes a list of identifiers of the virtual network requested by the terminal.

In another embodiment of the disclosure, a method by an access and mobility management function (AMF) in a wireless communication system includes receiving, from a terminal, a first message for a protocol data unit (PDU) session establishment request based on a user route selection policy (URSP) rule; selecting a session management function (SMF) based on a data network name (DNN) corresponding to the received first message; and transmitting a second message for creating a PDU session to the selected SMF, wherein the USRP rule is created by a policy control function (PCF), and the DNN is determined by the PCF.

In some embodiments, the method further includes receiving, from unified data management (UDM), UECM service information for determining whether the SMF exists, wherein the first message further includes a list of identifiers of a virtual network requested by the terminal.

In another embodiment of the disclosure, a method by a session management function (SMF) in a wireless communication system includes receiving, from an access and mobility management function (AMF), a second message for creating a PDU session; receiving, from unified data management (UDM), subscription data of a terminal that has transmitted a first message for a protocol data unit (PDU) session establishment request; selecting a policy control function (PCF) based on subscription data of the terminal; exchanging session management (SM) related policies with the selected PCF; generating, in case that the terminal belongs to a plurality of virtual networks, at least one of a quality of service (QoS) flow, a QoS rule, or a rule for a user plane function (UPF); and transmitting, to the terminal, information indicating that a PDU session has been established.

In some embodiments, the information indicating that the PDU session has been established includes the QoS rule and the quality of service (QoS) flow with a virtual network group.

In another embodiment of the disclosure, a policy control function (PCF) in a wireless communication system includes a transceiver configured to transmit and receive at least one signal; and a controller coupled to the transceiver, wherein the controller is configured to receive virtual network related information from an application function (AF), to determine whether to support a plurality of virtual networks with the same data network name (DNN) based on the received virtual network related information; to determine a DNN for the plurality of virtual networks in case that the plurality of virtual networks are supported with the same DNN, to create a user route selection policy (URSP) rule for the plurality of virtual networks, and to transmit the created URSP rule to a terminal constituting a virtual network.

In another embodiment of the disclosure, a terminal in a wireless communication system includes a transceiver configured to transmit and receive at least one signal; and a controller coupled to the transceiver, wherein the controller is configured to receive a user route selection policy (URSP) rule from a policy control function (PCF), to transmit a first message for a protocol data unit (PDU) session establishment request based on the USRP rule, and to receive information indicating that a PDU session has been established, and wherein the USRP rule is created by the PCF.

In another embodiment of the disclosure, an access and mobility management function (AMF) in a wireless communication system includes a transceiver configured to transmit and receive at least one signal; and a controller coupled to the transceiver, wherein the controller is configured to receive, from a terminal, a first message for a protocol data unit (PDU) session establishment request based on a user route selection policy (URSP) rule, to select an SMF based on a data network name (DNN) corresponding to the received first message, and to transmit, to the selected session management function (SMF), a second message for creating a PDU session, wherein the USRP rule is created by a policy control function (PCF), and the DNN is determined by the PCF.

In another embodiment of the disclosure, a session management function (SMF) in a wireless communication system includes a transceiver configured to transmit and receive at least one signal; and a controller coupled to the transceiver, wherein the controller is configured to receive, from an access and mobility management function (AMF), a second message for creating a PDU session, to receive, from unified data management (UDM), subscription data of a terminal that has transmitted a first message for a protocol data unit (PDU) session establishment request, to select a policy control function (PCF) based on the subscription data of the terminal, to exchange session management (SM) related policies with the selected PCF, to create at least one of a quality of service (QoS) flow, a QoS rule, or a rule for a user plane function (UPF) in case that the terminal belongs to a plurality of virtual networks, and to transmit, to the terminal, information indicating that a PDU session has been established.

### Advantageous Effects of Invention

Currently, the number of terminals using a mobile communication network and the number of services and applications for supporting the terminals are increasing exponentially. Further, in order to improve a quality of a mobile communication network, the design and operation of wireless networks and core networks are becoming increasingly sophisticated. In this situation, not only terminals using voice calls and data services, but also new types of terminals such as factories, unmanned aerial vehicles, robots, automobiles, and airplanes are emerging. The number of these new types of terminals is expected to increase continuously, and in order to effectively support these purposes, the mobile communication network is also expected to continuously evolve services.

In the disclosure, there has been developed a technology that supports a local area network (LAN) or virtual local area network (VLAN) technology, which is a technology for configuring a network configured with an existing wire in a mobile communication network, in a mobile communication network. Such technology was named a 5G LAN-type service based on Release 16 defined in 3GPP, and a network that supports communication of a group providing such a service was named a virtual network. The currently defined virtual network technology may be specified to a specific virtual network group ID, a virtual network membership, and virtual network data for providing virtual network communication, and by configuring or changing these parameters, it is possible to operate/manage the virtual network. However, in currently providing a virtual network, a 1:1 relationship should be maintained between a virtual network and a data network name (DNN), and one application has a limitation that it cannot access a plurality of virtual networks. Due to such a limitation, a specific application may access only a single physical virtual local area network among a plurality of physical virtual local area networks, and such PDU sessions are limited to the maximum 15 according to characteristics of mobile communication. Due to these disadvantages, there is a problem that the use of a free virtual network is remarkably hindered in case of a terminal for enterprise or management.

In order to solve such a problem, in the disclosure, by extending a specific application to access a plurality of virtual networks and enabling a single PDU session to transmit traffic to a plurality of virtual networks, the virtual network accessibility of the terminal can be increased, and the efficiency of terminals and radio resources can be increased. Effects obtainable in the disclosure are not limited to the above-mentioned effects, and other effects not mentioned may be clearly understood by those of ordinary skill in the art to which the disclosure belongs from the following description.

### BRIEF DESCRIPTION OF DRAWINGS

FIG. 1 illustrates a configuration of a virtual network group in a mobile communication system according to the disclosure.

FIG. 2 illustrates a method for a UE or an application to select a specific virtual network.

FIGS. 3A and 3B illustrate a method of supporting a plurality of virtual networks through a single PDU session.

FIGS. 4A and 4B illustrate a method through PDU session creation and acceptance modification when supporting a plurality of virtual networks through a single PDU session.

FIGS. 5A and 5B illustrate a method of selecting an SMF supporting a plurality of virtual networks.

FIG. 6 is a block diagram illustrating a structure of a UE according to an embodiment of the disclosure.

FIG. 7 is a block diagram illustrating a structure of a network entity according to an embodiment of the disclosure.

### MODE FOR THE INVENTION

Hereinafter, embodiments of the disclosure will be described in detail with reference to the accompanying drawings.

In describing embodiments, descriptions of technical contents that are well known in the technical field to which the disclosure pertains and that are not directly related to the disclosure will be omitted. This is to more clearly convey the gist of the disclosure without obscuring the gist of the disclosure by omitting unnecessary description.

For the same reason, some components are exaggerated, omitted, or schematically illustrated in the accompanying drawings. Further, the size of each component does not fully reflect the actual size. In each drawing, the same reference numerals are given to the same or corresponding components.

Advantages and features of the disclosure, and a method of achieving them will become apparent with reference to the embodiments described below in detail in conjunction with the accompanying drawings. However, the disclosure is not limited to the embodiments disclosed below, but may be implemented in various different forms, and only these embodiments enable the disclosure to be complete, and are provided to fully inform the scope of the disclosure to those of ordinary skill in the art to which the disclosure pertains, and the disclosure is only defined by the scope of the claims. Like reference numerals refer to like components throughout the specification.

In this case, it will be understood that each block of message flow diagrams and combinations of the message flow diagrams may be performed by computer program instructions. Because these computer program instructions may be mounted in a processor of a general purpose computer, special purpose computer, or other programmable data processing equipment, the instructions performed by a processor of the computer or other programmable data processing equipment generate a means that performs functions described in the message flow diagram block(s). Because these computer program instructions may be stored in a computer usable or computer readable memory that may direct a computer or other programmable data processing equipment in order to implement a function in a particular manner, the instructions stored in the computer usable or computer readable memory may produce a production article containing instruction means for performing the function described in the message flow diagram block(s). Because the computer program instructions may be mounted on a computer or other programmable data processing equipment, a series of operational steps are performed on the computer or other programmable data processing equipment to generate a computer-executed process; thus, instructions for performing a computer or other programmable data processing equipment may provide steps for performing functions described in the message flow diagram block(s).

Further, each block may represent a module, a segment, or a portion of a code including one or more executable instructions for executing specified logical function(s). Further, it should be noted that in some alternative implementations, functions recited in the blocks may occur out of order. For example, two blocks illustrated one after another may in fact be performed substantially simultaneously, or the blocks may be sometimes performed in the reverse order according to the corresponding function.

In this case, the term ‘-unit’ used in this embodiment means software or hardware components such as a field programmable gate array (FPGA) or application-specific integrated circuit (ASIC), and ‘-unit’ performs certain roles. However, ‘-unit’ is not limited to software or hardware. ‘-unit’ may be configured to reside in an addressable storage medium or may be configured to reproduce one or more processors. Therefore, as an example, ‘-unit’ includes components such as software components, object-oriented software components, class components, and task components, processes, functions, properties, procedures, subroutines, segments of program code, drivers, firmware, microcode, circuit, data, databases, data structures, tables, arrays, and variables.

Functions provided in the components and ‘-units’ may be combined into a smaller number of components and ‘-units’ or may be further separated into additional components and ‘-units’. Further, components and ‘-units’ may be implemented to reproduce one or more CPUs in a device or secure multimedia card. Further, in an embodiment, ‘-unit’ may include one or more processors.

In describing in detail embodiments of the disclosure, a radio access network new RAN (NR) in the 5G mobile communication standard specified by 3GPP, which is a mobile communication standardization organization, and a packet core (5G system, 5G core network, or next generation core (NG core)), which is a core network are the main target, but the main gist of the disclosure is applicable to other communication systems having a similar technical background with slight modifications within the scope not significantly departing from the scope of the disclosure, which will be possible by determination of a person skilled in the technical field of the disclosure.

Hereinafter, for convenience of description, some terms and names defined in the 3rd generation partnership project (3GPP) long term evolution standard (standards of 5G, NR, LTE, or similar systems) may be used. However, the disclosure is not limited by the terms and names, and may be equally applied to systems conforming to other standards. Hereinafter, a term identifying an access node used in the description, a term indicating network entities, a term indicating messages, a term indicating an interface between network entities, a term indicating various identification information and the like are exemplified for convenience of description. Accordingly, the terms are not limited to terms used in the disclosure, and other terms indicating objects having equivalent technical meanings may be used.

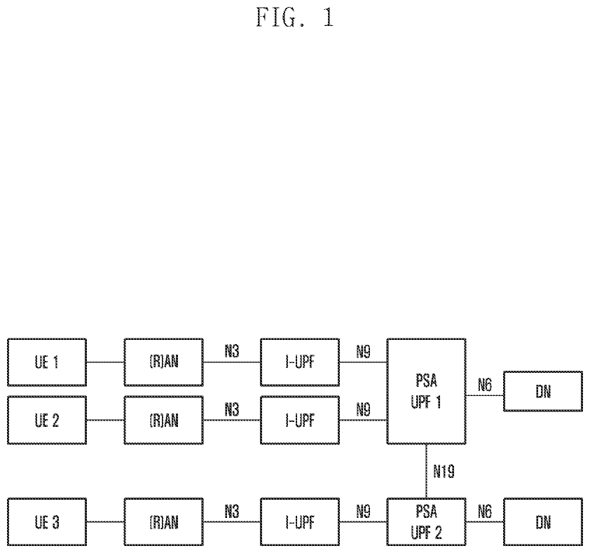

The disclosure relates to a method of supporting the operation of an unmanned aerial vehicle in a mobile communication system conforming to the 3GPP standard, and devices or objects described below may interact to achieve the object of the disclosure. Hereinafter, among various elements constituting a core network, devices directly related to the disclosure will be exemplarily described. A configuration diagram in which each element interacts using a service based interface is illustrated in FIG. 1.

An access and mobility management function (AMF) is a device for managing access and mobility of a terminal, and serves as a terminal-core network endpoint in which the terminal connects with other devices in a core network through a RAN. Functions provided by the AMF may include functions such as terminal registration, connection, reachability, mobility management, access identification/authentication, and mobility event creation.

A session management function (SMF) performs a PDU session management function of the terminal. For example, the SMF may perform functions such as a session management function through establishment, modification, and release of a session and maintenance of a tunnel between an UPF and an AN necessary for this, an IP address assignment and management function of the terminal, an ARP proxy function, user plane selection and control, traffic processing control in the UPF, charging data collection control, and the like. In relation to the virtual network support, the SMF may create rules that detect and transmit virtual network traffic.

A policy control function (PCF) plays a role of determining and providing policies for access/mobility and session management applied by the AMF and the SMF. For example, the PCF may govern the behavior of the entire network and provide policies to be implemented to network functions (NFs) constituting the control plane. Further, the PCF may access the unified data repository (UDR) to access information related to policy determination. In relation to the virtual network, when a specific terminal is a member of the virtual network, the PCF may play a role of acquiring relevant virtual network data from the UDR to provide a related policy to the terminal and the SMF.

A network exposure function (NEF) is responsible for transmitting or receiving events occurring in the mobile communication network and a support capability to or from the outside. For example, the NEF performs functions such as safely provisioning information of external applications to the core network, conversion of internal/external information, and storing and then redistributing functions received from other NFs in UDR. In relation to the virtual network, the NEF plays a role of transmitting data related to the virtual network configuration and operation from the AF. Parameters for managing the virtual network may include a virtual network group identifier, virtual network member information, virtual network group data, and the like.

Unified data management (UDM) and unified data repository (UDR) are independent network functions, but in this embodiment, functions and roles thereof are similarly used and described simultaneously. The UDM may perform, for example, creation of AKA authentication information for 3GPP security, processing of a user ID, reverse concealment of a subscriber concealed ID (SUPI), list management of NFs supporting a current UE, subscription management, short message (SMS) management, and the like. UDR may, for example, perform a function of storing and providing subscription data managed by the UDM, structured data for exposure, and application data related to the NEF or service. In relation to the virtual network, the UDM and the UDR play a role of storing virtual network related parameters received from the NEF and notifying relevant entities of the stored virtual network related parameters.

A user plane function (UPF) plays a role of processing actual user data, and plays a role of processing packets so that packets generated by the terminal may be transmitted to an external data network or data introduced from an external data network may be transmitted to the terminal. Main functions provided by the UPF may include, for example, functions such as performing an anchor role between radio access technologies, providing connectivity to PDU sessions and external data networks, packet routing and forwarding, packet inspection, and user plane policy application, traffic usage report generation, and buffering. In relation to the virtual network, the UPF plays a role of transmitting traffic received from the virtual network member to other members. In this case, the member of the virtual network may be positioned in the same mobile communication network or an external data network such as the Internet.

A network data analytics function (NWDAF) may collect events or information occurring within the network and transmit statistics, predictions, and recommendation information related to specific information to the NF, AF, and OAM using tools such as analysis tools or machine learning. For example, the NWDAF may perform functions such as collecting data from the NF/AF/OAM, registering an NWDAF service and exposing metadata, and providing network analysis information to the NF/AF.

A UE radio capability management function (UCMF) performs a function of storing and providing mapping information between an ID of a radio access related function of the terminal allocated by a PLMN or allocated by the manufacturer and an actual function in the form of a dictionary.

An application function (AF) performs a function of interworking with a core network of 3GPP in order to provide services. The AF may be largely divided into trusted and untrusted, and the trusted AF may utilize services of network functions positioned inside the core network without a separate intermediate function such as the NEF. Representative functions provided by the AF may include application influence on traffic routing, utilization of a network information exposure function, an interaction with a policy framework for the policy control, and an IMS related interaction. In relation to the virtual network, by transmitting virtual network related data to the NEF, the AF may operate/manage the virtual network.

An operation, administration and maintenance (OAM) is a device for managing the entire mobile communication network including a base station and a core network. For example, the OAM may perform functions related to operation, management, maintenance, provisioning, and problem solving of communication networks. Further, the OAM may perform a function of monitoring and configuring each base station or core network to operate smoothly according to a design and policy. The OAM is a concept that encompasses all tools and procedures related to management, and does not refer to a specific device, but may include all tools, software, and procedures used by a network manager for management.

3GPP defines a method of providing a virtual private network configured with specific terminals in a mobile communication network. Terminals constituting a virtual private network may be positioned inside the mobile communication network or may be positioned inside the mobile communication network through an external data network, and are identified using a generic public subscription identifier (GPSI). When an operator of the mobile communication network provides information related to the management/operation of the virtual network through the AF or the OAM, which is a management system, the operation/management of the virtual network is performed. In this case, the AF may use an interface provided by the NEF. Information related to a virtual network may be largely divided into three types: virtual network group identifier, virtual network group membership, and virtual network group data. The virtual network group identifier is an identifier for identifying a specific group from other virtual network groups, and the virtual network membership includes identifiers for terminals constituting the virtual network group. In this case, each terminal is identified through a GPSI. The virtual network group data may include information related to a PDU session for using the virtual network, and include an S-NSSAI, PDU session type, data network name, and application descriptor.

When virtual network group related information is transmitted to the core network through the OAM or the AF, the core network stores and manages the virtual network group related information through the UDM. In general, the AF positioned outside the network transmits virtual network related information and parameters through the NEF, and may use a Nnef_ParameterProvisioning service provided by the NEF. By using a create operation in case of creating a virtual network group for the first time, a update operation in case of changing a virtual network group, a get operation in case of referring to transmitted data, and a delete operation in case of deleting data or parameters, virtual network group related information may be transmitted to the core network. In case that the related service operates in the NEF, the NEF stores data or parameters received from the AF in the UDM. In this case, a group identifier of the virtual network is expressed as an external group identifier used by the AF, and the UDM newly allocates an internal group ID that identifies a group inside the network or updates data corresponding to an existing internal group identifier, thereby storing information received from the NEF. Based on the information received from the NEF, the UDM may update an internal group ID list that expresses whether a specific terminal is included in a specific group in subscription data of each terminal stored in the UDR. Further, the UDM may store or update a mapping relationship between an external identifier and an internal identifier and membership information of each group. Further, virtual network group data may be stored in the UDR. In a process of acquiring subscription data from the UDM, when a specific terminal configures a virtual network group, the UDM may transmit virtual network group data together with subscription data related to access management (AM) and session management (SM).

A terminal constituting the virtual network may access the virtual network with reference to a user route selection policy (URSP), which is a policy created by the PCF and transmitted to the terminal. When traffic created by the terminal satisfies conditions specified in the URSP, in order for the terminal to recognize whether the traffic should be transmitted to the virtual network and to transmit the traffic, a new PDU session satisfying a virtual network name (DNN), S-NSSAI, and PDU session type included in the virtual network group data is created. In case that a corresponding PDU session has already been created, the UE transmits data through the existing PDU session. In case that the above-described virtual network group related information is newly created or modified in the UDR, the PCF may bring relevant information from the UDR to create or update a new URSP. Currently, a virtual network group defined by 3GPP provides only 1:1 relationship between specific data network names.

When a PDU session establishment request from a specific terminal is transmitted to the SMF, the SMF determines whether the request is communication to the virtual network with reference to the DNN, S-NSSAI, and PDU session types among PDU session request information, and requests network group related data to the UDM based on this. Based on this, packet detection and processing rules are transmitted to the UPF for providing a connection between terminals constituting a specific virtual network. In the current 3GPP standard, PDU sessions related to a specific virtual network may be processed only in a single SMF. When a plurality of UPFs are involved to configure a user data route, virtual network related data may be transmitted between PDU session anchor UPFs (PSA UPFs) by using an N19 tunnel. In order to transmit virtual network group traffic, the UPF may use local switching in which packets are forwarded within a single UPF, N19-based forwarding that transmits data between PSA UPFs, and N6-based forwarding that communicates with external data networks. In case of using N6-based forwarding, the AF may request so that virtual network group traffic corresponding to a specific external group identifier may be transmitted to a specific data network access identifier (DNAI) through an AF influence traffic routing request.

FIG. 1 illustrates a virtual network group configured by UEs connecting virtual networks. In FIG. 1, a UE1 and a UE2 are locally switched through a PSA UPF1 to support communication with each other, and a UE3 may communicate using N19 between the UE1 or the UE2 and the PSA UPF1 and a PSA UPF2. In order to communicate with a server or a UE positioned in an external network, communication is possible through a DN connected to the PSA UPF. In this case, in case of wanting to select a DNAI to transmit traffic to a specific PSA UPF, an AF influence traffic routing request may be used, and tunnel information used in N6 may be provided together.

When traffic created by a specific application or an application matches the rule defined in the URSP, access to the virtual network group in a currently defined mobile communication network provides a DNN, S-NSSAI, PDU session type, SSC mode, and access type preference related to a route required to transmit traffic through a route selection descriptor in the USRP; thus, the UE creates a new PDU session or transmits traffic using a PDU session that satisfies the above characteristics. In this case, applications are mapped 1:1 with DNNs connected to a specific virtual network group. Therefore, a specific application can access only one virtual network through one DNN. The current virtual network technology has two major problems. First, the total number of PDU sessions capable of being created by the UE is limited to a specific number, and may be, for example, 15. In case that general services such as a telephone and Internet are simultaneously used, the number of simultaneously accessible virtual networks may be smaller than this. Additionally, in case of matching a specific application and traffic in order to access a virtual network, there occurs a problem that a single application should use only a specific virtual network. For example, it is not possible for a specific application to allow simultaneous access to a plurality of groups. Therefore, the UE has a disadvantage that it should use only a specific virtual network until a PCF transmits a new URSP policy.

Information exchange and control signal exchange between the aforementioned entities uses procedures, interfaces, and protocols defined in the 3GPP standard specification document. However, all terms included in the disclosure are not limited by the 3GPP terms and names, and may be equally applied to systems and devices conforming to other standards. In describing in detail embodiments of the disclosure, the 3GPP will mainly target the communication standard configured by the standard, but the main gist of the disclosure is applicable to other communication systems having a similar technical background with slight modifications within the scope not significantly departing from the scope of the disclosure, which will be possible by determination of those of ordinary skill in the technical field of the disclosure.

### [Embodiment 1]—a Method of Allowing Simultaneous Access of a Single Application to a Plurality of Virtual Networks

In case of using the URSP rule provided by a PCF defined in the current 3GPP standard, a specific single application may only access a specific virtual network group, and it is impossible for a specific single application to simultaneously access a plurality of virtual networks.

Table 1 includes a URSP rule that defines a transmission method to a specific route or a specific PDU session allowed by the current standard. Traffic to which the URSP rule is applied may be operated through a method of identifying whether it is included in a detailed rule included in a traffic descriptor to acquire information included in a specific route selection descriptor. Accordingly, when traffic in which a specific application intends to transmit is included in the traffic descriptor, a specific PDU session is created or an existing PDU session is selected. The traffic descriptor used in this case includes an application descriptor that distinguishes a specific application, an IP descriptor that distinguishes IP related tuple information, a domain descriptor that specifies a destination FQDN, a non-IP descriptor for non-IP traffic, a data network name (DNN), and a connection capability. In the disclosure, it is expressed as a specific application, but traffic having specific characteristics or patterns such as addresses and ports may also be differentiated and applied through the disclosure.

TABLE 1
URSP policy defined in the existing 3GPP

| | | | PCF permitted | |
|---|---|---|---|---|
| Information | | | to modify in | |
| name | Description | Category | a UE context | Scope |
| Rule Precedence | Determines the order the URSP | Mandatory | Yes | UE context |
| | rule is enforced in the UE. | (NOTE 1) | | |
| Traffic | This part defines the Traffic | Mandatory | | |
| descriptor | descriptor components for the | (NOTE 3) | | |
| | URSP rule. | | | |
| Application | It consists of OSId and | Optional | Yes | UE context |
| descriptors | OSAppId(s).(NOTE 2) | | | |
| IP descriptors | Destination IP 3 tuple(s) (IP | Optional | Yes | UE context |
| (NOTE 5) | address or IPv6 network prefix, | | | |
| | port number, protocol ID of the | | | |
| | protocol above IP). | | | |
| Domain | Destination FQDN(s) | Optional | Yes | UE context |
| descriptors | | | | |
| Non-IP | Descriptor(s) for destination | Optional | Yes | UE context |
| descriptors | information of non-IP traffic | | | |
| (NOTE 5) | | | | |
| DNN | This is matched against the DNN | Optional | Yes | UE context |
| | information provided by the | | | |
| | application. | | | |
| Connection | This is matched against the | Optional | Yes | UE context |
| Capabilities | information provided by a UE | | | |
| | application when it requests a | | | |
| | network connection with certain | | | |
| | capabilities.(NOTE 4) | | | |
| List of Route | A list of Route Selection | Mandatory | | |
| Selection | Descriptors. The components of a | | | |
| Descriptors | Route Selection Descriptor are | | | |
| | described in table 6.6.2.1-3. | | | |

In order to enable a single application or specific type of traffic to simultaneously access a plurality of virtual networks, by expanding a traffic descriptor within the URSP rule, the disclosure may allow to explicitly match an external virtual network group identifier or an internal virtual network group identifier. Thereby, traffic and a virtual network in which an application intends to access at a specific time point may be separated for each virtual network. For example, in case that an application intends to communicate with a group named VN1, in order to select a PDU session related route, the URSP may additionally provide an internal or external virtual network group identifier of VN1. The URSP may return a DNN for VN1, S-NSSAI for VN1, and PDU session type for VN1, corresponding to the VN1. Additionally, in case of accessing VN2, the application may provide an internal or external virtual network group identifier of the VN2 to acquire virtual network configuration data distinguished from the VN1. In each example, even in the same traffic, virtual networks may be distinguished according to the provided virtual network group identifier, and it is possible for a specific application to simultaneously access a plurality of virtual networks by establishing different PDU sessions. The policy of the extended URSP is illustrated in Table 2.

TABLE 2
Extended URSP Policy

| | | | PCF permitted | |
|---|---|---|---|---|
| Information | | | to modify in | |
| name | Description | Category | a UE context | Scope |
| Rule Precedence | Determines the order the URSP | Mandatory | Yes | UE context |
| | rule is enforced in the UE. | (NOTE 1) | | |
| Traffic | This part defines the Traffic | Mandatory | | |
| descriptor | descriptor components for the | (NOTE 3) | | |
| | URSP rule. | | | |
| Application | It consists of OSId and | Optional | Yes | UE context |
| descriptors | OSAppId(s). (NOTE 2) | | | |
| IP descriptors | Destination IP 3 tuple(s) (IP | Optional | Yes | UE context |
| (NOTE 5) | address or IPv6 network prefix, | | | |
| | port number, protocol ID of the | | | |
| | protocol above IP). | | | |
| Domain | Destination FQDN(s) | Optional | Yes | UE context |
| descriptors | | | | |
| Non-IP | Descriptor(s) for destination | Optional | Yes | UE context |
| descriptors | information of non-IP traffic | | | |
| (NOTE 5) | | | | |
| DNN | This is matched against the DNN | Optional | Yes | UE context |
| | information provided by the | | | |
| | application. | | | |
| Connection | This is matched against the | Optional | Yes | UE context |
| Capabilities | information provided by a UE | | | |
| | application when it requests a | | | |
| | network connection with certain | | | |
| | capabilities. (NOTE 4) | | | |
| External VN | This is matched against the | Optional | Yes | UE context |
| Group ID | external group ID provided by | | | |
| | the application | | | |
| Internal VN | This is matched against the | Optional | Yes | UE context |
| Group ID | internal group ID provided by | | | |
| | the application | | | |
| List of Route | A list of Route Selection | Mandatory | | |
| Selection | Descriptors. The components of a | | | |
| Descriptors | Route Selection Descriptor are | | | |
| | described in table 6.6.2.1-3. | | | |

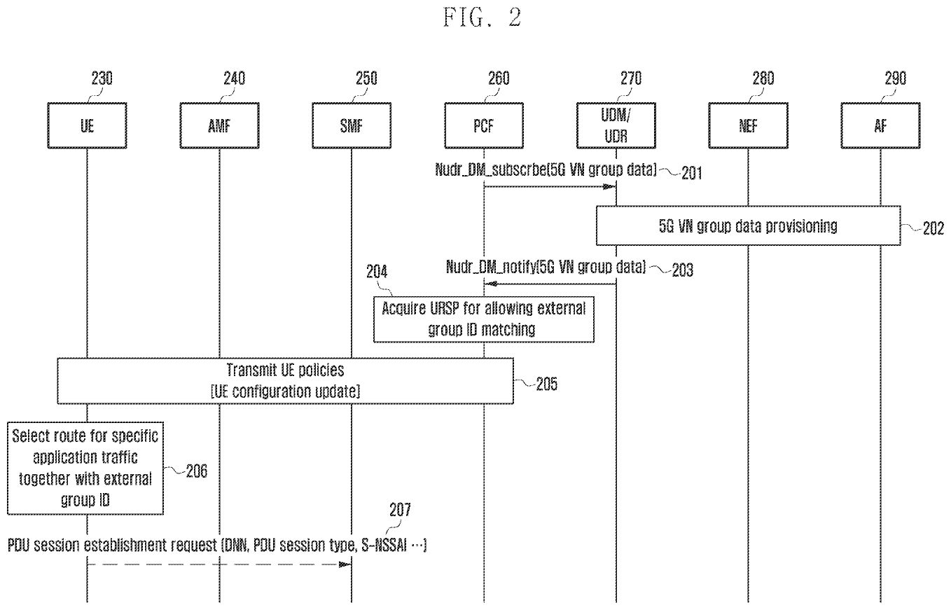

A process in which the PCF transmits a URSP policy for a specific UE to access a virtual network is illustrated in FIG. 2.

In step 201, in order to detect generation of new virtual network group information or a change in existing virtual network group related information, a PCF 260 may subscribe to a related event to a UDR 270.

In step 202, an AF 290 may transmit virtual network related information (virtual network identifier, virtual network membership, virtual network (configuration) data) to the UDR 270 through UDM 270. In this case, an NEF 280 may be used, and it is also possible for OAM to directly transmit data through the UDM 270 or the UDR 270.

In step 203, the UDM 270 may notify the PCF 260 that has requested a subscription of the related event in step 201 that virtual network related data has been created or modified.

In step 204, the PCF 260 may recognize that the URSP of a specific UE should be newly transmitted or updated through the transmitted virtual network related information, and create a new URSP rule for each UE. In this case, the created USRP rule may include a rule supporting an extended traffic descriptor that allows matching of an internal or external virtual network group identifier.

In step 205, the PCF 260 may transmit the created USRP rule to the UE 230.

In step 206, in case that the UE 230 should access a specific virtual network and knows an internal or external identifier of the virtual network group to be accessed, the UE 230 may explicitly match the internal or external identifier to the URSP to acquire PDU session related information or a route that can access a virtual network to be transmitted.

In step 207, the UE 230 may establish a new PDU session using virtual network related configuration data acquired through matching of the URSP rule or may transmit data to an SMF 250 using an existing PDU session in case that there is an existing PDU session.

### [Embodiment 2]—a Method of Allowing Access to a Plurality of Virtual Networks Using a Single PDU Session

According to the standard defined in the current 3GPP, in order to access a virtual network, a mobile communication UE establishes a PDU session through a DNN assigned to a specific virtual network group and transmits and receives data through the PDU session. Accordingly, the virtual network and the DNN has a 1:1 relationship. Accordingly, the number of PDU sessions capable of being established by the UE is limited to 15. Further, in case of adding access to a new virtual network, the UE has the disadvantage that a new PDU session should always be established. The disclosure includes a method of enabling a plurality of virtual network groups for solving such a problem to use the same DNN name, and distinguishing traffic generated in each virtual network.

In the disclosure, a case of providing a plurality of virtual network groups are through the same DNN may be largely divided into two cases. The first case is a case in which the same DNN is used in step of transmitting virtual network group related information by the AF or OAM, but a case of transmitting a plurality of groups. In this case, different virtual network groups may be distinguished through virtual network identifiers. The second case is a case that the AF or OAM has transmitted different virtual network group identifiers and different DNNs as virtual network group configuration information and that the PCF changes a name of the received DNN to a different name while the PCF transmits the URSP to the UE. According to the current 3GPP standard, because only a 1:1 relationship is provided between a virtual network group and a DNN, it is a configuration of a virtual network group that cannot be provided. The disclosure includes a method of extending virtual network group information to support virtual network group communication using the name of the same DNN.

The disclosure includes a method for a UE to support a DNN supporting a plurality of virtual networks. In order to distinguish traffic generating in a plurality of PDU sessions sharing the same DNN, packets are encapsulated or a separate quality of service (QoS) flow identifier (QFI) is allocated to distinguish traffic in a section between the UE and the PSA UPF.

As a method for the UE to distinguish traffic of a specific virtual network group from traffic of other groups or general traffic, the disclosure includes a method of additionally using a traffic descriptor including characteristics of traffic additionally generated by the specific virtual network while the AF or OAM transmits virtual network group related data. For example, in case that an Ethernet PDU session type is used, it may be expressed as a combination of an Ethertype, customer/service VLAN tag information, a destination address, a specific port address, and the like included in the header. Such a combination may be configured with a combination of filters that may be included in a packet filter set defined in the 3GPP standard. According to a PDU session type used in the virtual network group, the packet filter set may be subdivided into an IP packet filter set and an Ethernet packet filter set. As a representative method for distinguishing a virtual network group, traffic for a specific virtual network group may be distinguished within a single PDU session using a VLAN tag in a PDU session created in the Ethernet type, an IP header address, and port information inside the Ethernet header.

In order to support a plurality of virtual network groups to communicate using the same PDU session according to the purpose, the PCF may configure the same DNN in the USRP rule assigned to the UE. In this case, virtual networks merged into the same DNN should identify whether the virtual network traffic is possible. For example, in case that two or more virtual network groups use the same VLAN tag, two virtual network groups cannot be supported through the same DNN. However, in case that traffic for each virtual network may be distinguished through a combination of additional packet filters such as an internal IP address, it is allowed to establish a PDU session with a single DNN. In this case, in case that information of a DNN included in each virtual network group data is transmitted from the AF, the PCF may allocate a DNN representing a plurality of virtual networks. Thereby, the UE can simultaneously communicate with a plurality of virtual network groups using a single PDU session.

A UE to which a plurality of virtual network groups are mapped creates a PDU session in order to communicate with the virtual network group. In this case, in order to separate traffic created in each virtual network group, the SMF classifies traffic having the above traffic characteristics into specific virtual network traffic. The classified traffic performs different forwarding rules for each virtual network group. Therefore, while the SMF creates a PDU session supporting a plurality of virtual network groups, the SMF may create an N4 session in the UPF and create a packet detection rule (PDR) and a forwarding action rule (FAR) for each virtual network. Additionally, the SMF may transmit QoS related policies and monitoring policies according to the 3GPP standard specification. For example, there are two virtual network groups VN1 and VN2. The VN1 has a UE1 and a UE2 as members, and the VN2 has a UE1 and a UE3 as members. As a traffic characteristic of each virtual network group, traffic may be distinguished with VLAN ID=1 and VLAN ID=2. The SMF may create a PDR rule that enables the UPF to identify each virtual network group with a VLAN ID in an Ethernet header to create a separate packet forwarding rule for each virtual network group. A PDR for the VN1 includes a rule capable of detecting VLAN ID=1, and a rule capable of transmitting a packet to a UE1 and a UE2. A PDR for the VN2 includes a rule capable of detecting VLAN ID=1, and includes a rule capable of supporting communication between a UE1 and a UE3. Even in case that N6 is used, each virtual network traffic may be separated according to the 3GPP standard and then traffic may be transmitted to separate N6.

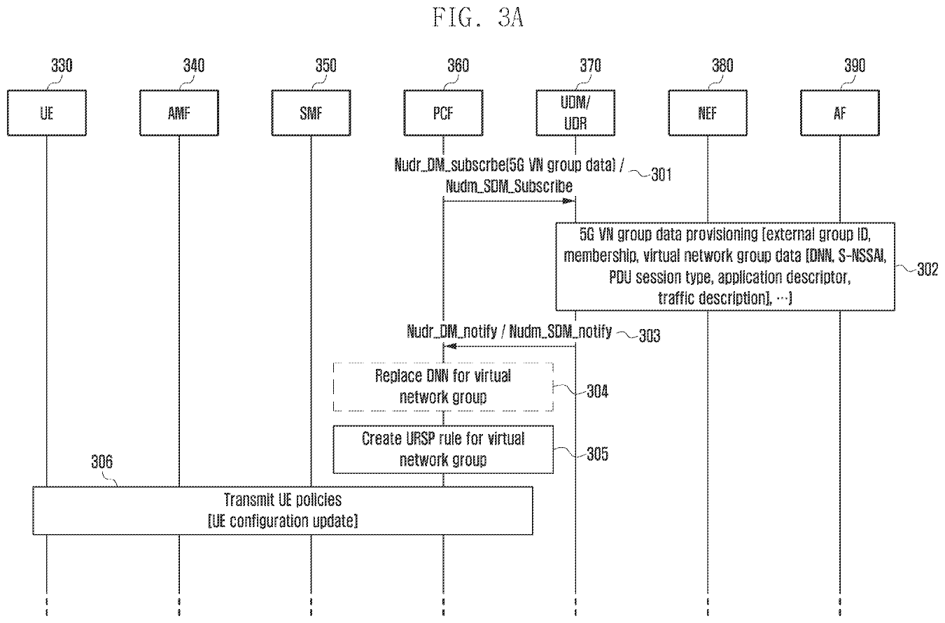

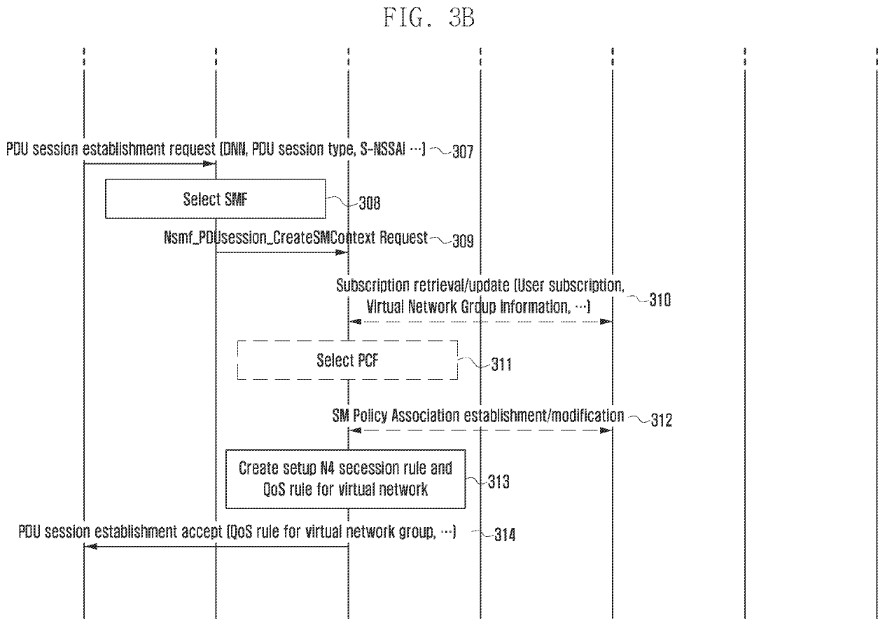

A process for executing the disclosure is illustrated in FIGS. 3A and 3B.

FIGS. 3A and 3B illustrate a method of supporting a plurality of virtual networks through a single PDU session.

In step 301, in order to detect that new virtual network group related information or existing virtual network group related update information is transmitted from an OAM or AF 390, a PCF 360 may request subscription to a UDM 370 or UDR 370.

In step 302, the AF 390 or OAM may transmit a virtual network group ID, virtual network group membership, and virtual network group data, which are virtual network group related information. In this case, such information may be transmitted through an NEF 380. In the disclosure, it is characterized in that a traffic descriptor capable of distinguishing virtual network traffic from other traffic as well as a DNN, S-NSSAI, PDU session type, and application descriptor used by the virtual network group is additionally transmitted to virtual network group data. The transmitted virtual network group related information may be stored in the UDR 370 through the UDM 370.

In step 303, the PCF 360 may receive new virtual network related information.

In step 304, the PCF 360 may determine whether to support a plurality of virtual networks using the same DNN based on the received virtual network related information. In this case, as described above, the PCF 360 should identify whether virtual network traffic supported through the same DNN may be distinguished. In case that a plurality of virtual networks are supported through the same DNN, the PCF 360 may select a representative DNN or may create a new DNN.

In step 305, a UE 330 may create a URSP rule for supporting access to the virtual network group. In this case, the URSP may create a URSP rule so as to support a plurality of virtual networks through the representative DNN determined in step 304. In this case, in case of the UE 330 simultaneously belonging to a plurality of virtual networks, a traffic descriptor and route selection policy should be configured to create a PDU session with the representative DNN.

In step 306, the created URSP rule may be transmitted to the UEs 330 constituting the virtual network. A UE configuration update procedure defined in 3GPP may be used.

In step 307, in order to access a specific virtual network group, the UE 330 may transmit a first message including a PDU session establishment request. In this case, the USRP created in step 305 may be used, and a DNN supporting a plurality of virtual networks may be selected.

In step 308, an AMF 340 may select an appropriate SMF by viewing the DNN while receiving and processing a first message including the PDU session establishment request. In this case, in case that there is a PDU session connected to the representative DNN in another UE, the same SMF should be selected.

In step 309, in order to create a PDU session, the AMF 340 may transmit a second message to an SMF 350. The second message may include a PDUsession_createSMcontext request.

In step 310, the SMF 350 may receive subscription data of the UE 330 that has transmitted a first message including a PDU session establishment request from the UDM 370. In this case, in case that the UE 330 is a member of the virtual network group, virtual network related information may be transmitted together.

In step 311, the PCF 360 for receiving the SM related policy may be selected.

In step 312, the SMF 350 may establish SM_Policy_Association for SM related policy exchange with the PCF 360 selected in step 311.

In step 313, in case that the UE 330 belongs to a plurality of virtual networks, the SMF 350 may create a QoS rule and a packet processing rule to be performed in the UPF in order to distinguish each traffic.

In step 314, the SMF 350 transmits information that the PDU session has been established to the UE 330, and in case that an additional QoS rule is created in step 313, the additional QoS rule may be transmitted together.

### [Embodiment 3]—Method of Transmitting an Explicit Virtual Network Group Identifier and a Configuration for Each Group when Creating a PDU Session

The disclosure includes a method of transmitting a plurality of virtual network groups through a single PDU session. A feature of the disclosure includes a method of requesting together an identifier of a virtual network group to be accessed through a PDU session in case that a PDU session for communication of a virtual network group is created. Additionally, with respect to a PDU session creation request, the SMF may allocate an accessible QFI to each virtual network group and notify the UE of the mapping relationship between a virtual network group identifier and a QoS flow. The UE identifies whether traffic is transmitted to a specific virtual network with reference to the QoS rules. In order to transmit traffic to a specific virtual network, the UE may select a QoS flow to be used by using mapping relationship information between the received virtual network group identifier and the QoS flow. In this process, in case that an identifier of the virtual network group is not transmitted while the UE requests the creation of a PDU session, the SMF may transmit mapping information with a QoS flow for an available virtual network group in the requested DNN, S-NSSAI, and PDU session types. The mapping information represents a mapping relationship between a specific virtual network and a QoS flow, and the QoS flow may be identified through a QoS flow ID (QFI). For example, in case that there are virtual network VN1, virtual network VN2, QoS flow QF1, and QoS flow QF2, a specific virtual network may transmit information related to available QoS flows as in {(VN1, QF1), (VN1, QF)}. In case that a PDU session has been established or modified, such mapping information may be transmitted as a parameter of the PDU session establish accept or PDU session modification command, which is a related message. In this case, newly added mapping information may be added as a new parameter of the message, or by extending the QoS flow parameter or a protocol configuration option, newly added mapping information may be transmitted to the UE.

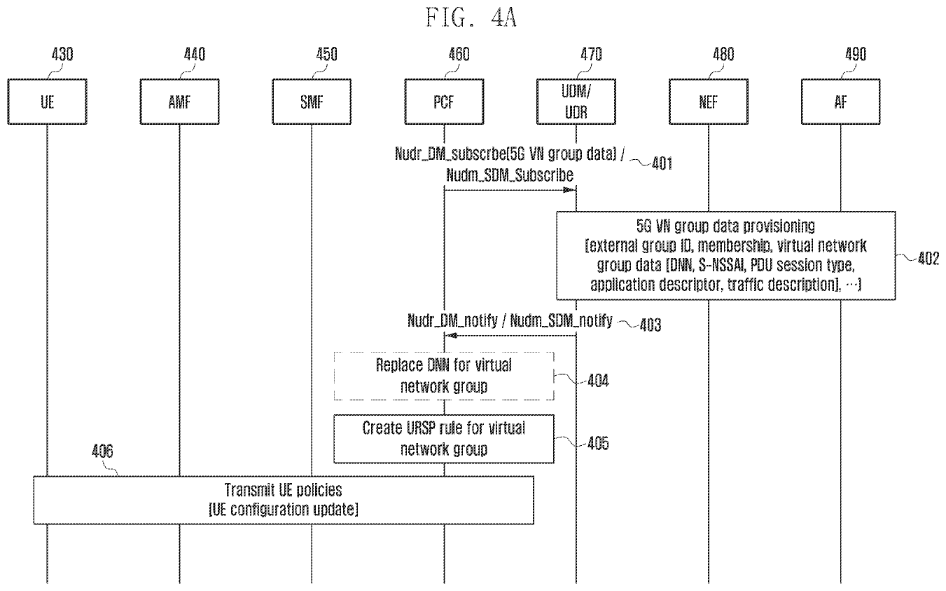

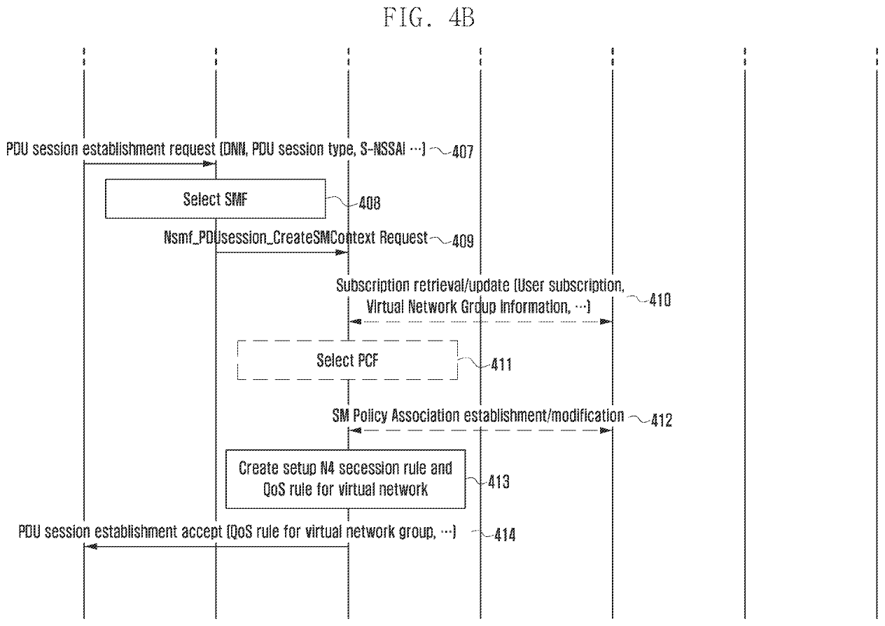

Procedures necessary for executing the disclosure are illustrated in FIGS. 4A and 4B.

FIGS. 4A and 4B illustrate a method through PDU session creation and acceptance modification when supporting a plurality of virtual networks through a single PDU session.

In step 401, in order to detect that new virtual network group related information or existing virtual network group related update information is transmitted from an OAM or AF 490, a PCF 460 may request a subscription to a UDM 470 or UDR 470.

In step 402, the AF 490 or OAM may transmit a virtual network group ID, virtual network group membership, and virtual network group data, which are virtual network group related information. In this case, such information may be transmitted through an NEF 480. In the disclosure, it is characterized that a traffic descriptor capable of distinguishing virtual network traffic from other traffic as well as a DNN, S-NSSAI, PDU session type, and application descriptor used by the virtual network group is additionally transmitted to the virtual network group data. The transmitted virtual network group related information may be stored in the UDR 470 through the UDM 470. In this case, the traffic descriptor of the virtual network group may be an additionally included parameter (optional parameter).

In step 403, the PCF 460 may receive new virtual network related information.

In step 404, the PCF 460 may determine whether to support a plurality of virtual networks using the same DNN based on the received virtual network related information.

In this case, as described above, the PCF 460 should identify whether virtual network traffic supported through the same DNN may be distinguished. When a plurality of virtual networks are supported through the same DNN, the PCF 460 may select a representative DNN or may create a new DNN.

In step 405, the PCF 460 may create a URSP rule for enabling the UE 430 to support access to a virtual network group. In this case, the URSP may create a URSP rule so as to support a plurality of virtual networks through the representative DNN determined in step 404. In this case, in the case of the UE 430 simultaneously belonging to a plurality of virtual networks, a traffic descriptor and a route selection policy should be configured to create a PDU session with a representative DNN.

In step 406, the created URSP rule may be transmitted to the UEs 430 constituting the virtual network. A UE configuration update procedure defined in 3GPP may be used. In step 407, in order to access a specific virtual network group, the UE 430 may transmit a first message including a PDU session establishment request. The USRP created in step 405 is used, and a DNN supporting a plurality of virtual networks may be selected. Additionally, in case that the UE 430 knows information on the virtual network group to be used at the current time point, a list of identifiers of the virtual networks requested by the UE 430 at the current time point may be included together in the request.

In step 408, an AMF 440 may select an appropriate SMF with reference to the DNN while processing the first message including the PDU session establishment request. In this case, in case that there is a PDU session connected to the representative DNN in another UE, the same SMF should be selected.

In step 409, in order to create a PDU session, the AMF 440 may transmit a second message to an SMF 450. The second message may include a PDUsession_createSMcontext request.

In step 410, the SMF 450 may receive subscription data of the UE 430 that has sent the PDU session establishment request from the UDM 470. In this case, in case that the UE 430 is a member of the virtual network group, virtual network related information may be transmitted together.

In step 411, the SMF 450 may select the PCF 460 for receiving the SM related policy.

In step 412, the SMF 450 may establish SM_Policy_Association for SM related policy exchange with the PCF 460 selected in step 411.

In step 413, when the UE 430 belongs to a plurality of virtual networks, the SMF 450 may generate a QoS flow for supporting a plurality of virtual network groups, a QoS rule for supporting this, and a rule for the UPF. Additionally, the SMF 450 may create a mapping relationship between each QoS flow and a virtual network group. In this case, in case that the UE 430 belongs to a plurality of virtual networks, the SMF 450 may create a QoS rule and a packet processing rule to be performed in UPF to distinguish each traffic.

In step 414, the SMF 450 transmits to the UE 430 that the PDU session has been established, and in case that a plurality of virtual networks are supported, the mapping relationship between the virtual network group and the QoS flow generated in step 413 and additional QoS rules may be transmitted together. In this case, mapping information may be added as a new parameter of the PDU session establishment accept message, or by extending a QoS flow description, the QoS flow description may include mapping information therein or by extending a protocol configuration option, the protocol configuration option may include mapping information therein.

### [Embodiment 4]—a Method of Selecting an SMF when Creating PDU Sessions for a Plurality of Virtual Networks

The disclosure includes a method of enabling a plurality of UEs to select the same SMF when a PDU session supports a plurality of virtual networks. According to the current 3GPP standard, in case of an SMF supporting a virtual network, all UEs using the virtual network should be supported by the same SMF. Therefore, in case of using a plurality of virtual networks, the SMF should manage all PDU sessions related to the plurality of virtual networks to be supported. Therefore, when creating a PDU session for virtual network group communication, the same SMF should be selected.

The disclosure includes a method of enabling to include information on replacement of a DNN for supporting a virtual network group and whether to merge with other virtual network groups by expanding virtual network group data. When a virtual network DNN is replaced through the embodiment of the disclosure, the AMF, SMF, and PCF, which are related network functions of 5GS may determine that DNN information of the current virtual network has been replaced or merged by including the replaced DNN. Further, when first virtual network group data is transmitted so that the same DNN supports a plurality of virtual networks, such a shared DNN indicator may be transmitted.

When a PDU session establishment request comes from a specific UE with a DNN supporting a plurality of virtual networks, the AMF may bring subscription data on whether the UE may use virtual network group data through UDM. In this case, the AMF may identify whether the UE is a member of a virtual network group and whether a specific virtual network is merged. Through this information, the AMF may know whether the requested PDU session has been accessed to a specific virtual network, and that when an SMF is selected, all PDU sessions should be managed through a specific SMF. In this process, in order to select the SMF, the AMF may extend virtual network group data so as to find SMF instances supporting virtual network groups through a UECM service supported by the UDM. In case that there is no SMF supporting the requested DNN, the SMF is selected in consideration of the above information, knowing that it is a first SMF selection. The selected SMF may register or update the UDM using the UECM service so that a PDU session request for a virtual network group from another UE may be processed in the corresponding SMF. In this case, a virtual network group identifier or a DNN may be added as a use parameter.

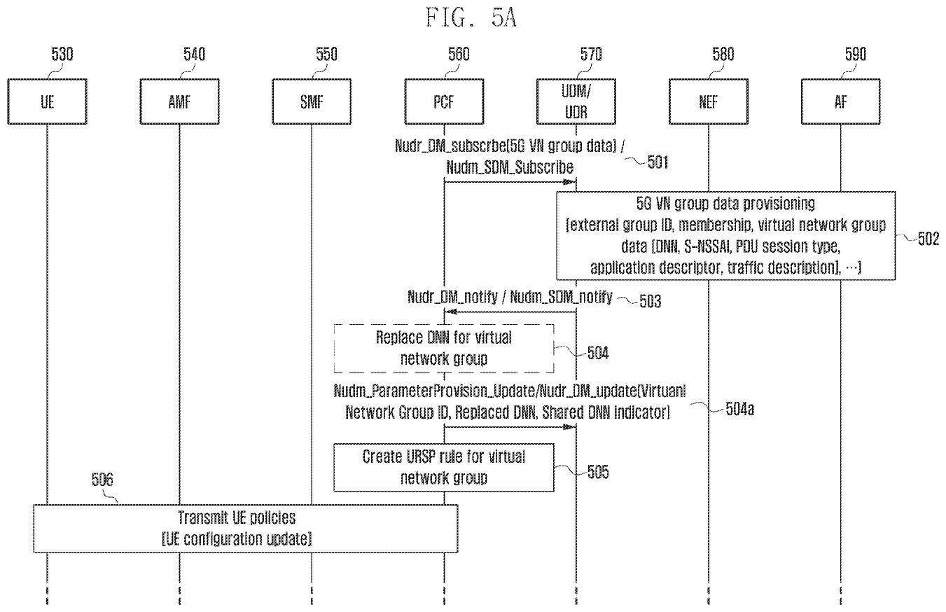

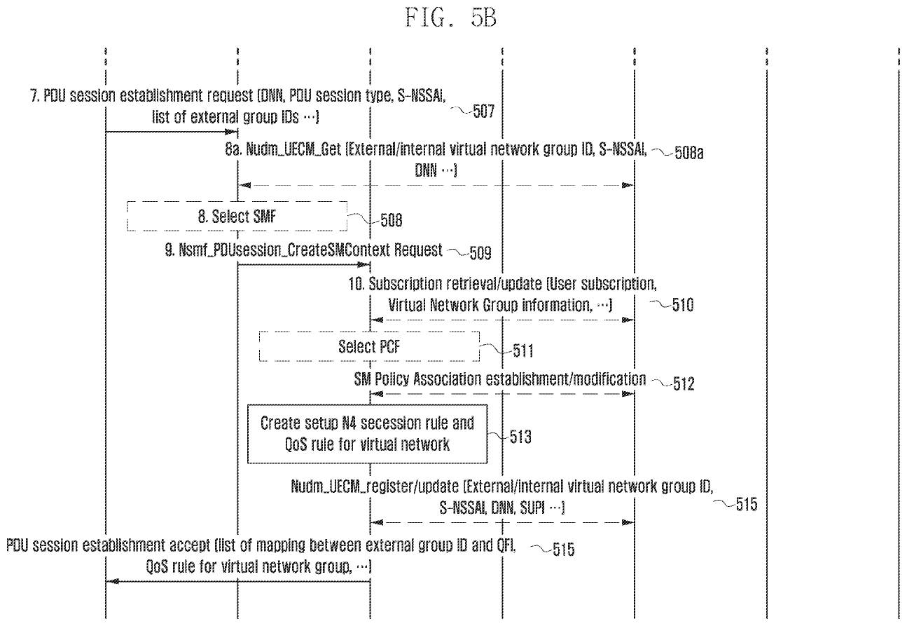

An execution procedure according to the disclosure is illustrated in FIGS. 5A and 5B.

FIGS. 5A and 5B are based on the Embodiment 3, and are equally applicable to the Embodiment 2.

FIGS. 5A and 5B illustrate a method of selecting an SMF supporting a plurality of virtual networks.

In step 501, in order to detect that new virtual network group related information or existing virtual network group related update information is transmitted from an OAM or AF 590, a PCF 560 may request a subscription to a UDM 570 or UDR 570.

In step 502, the AF 590 or OAM transmits a virtual network group ID, virtual network group membership, and virtual network group data, which are virtual network group related information. In this case, such information may be transmitted through an NEF 580. In the disclosure, it is characterized that a traffic descriptor capable of distinguishing virtual network traffic from other traffic as well as a DNN, S-NSSAI, PDU session type, and application descriptor used by the virtual network group is additionally transmitted to the virtual network group data. The transmitted virtual network group related information is stored in a UDR 570 through a UDM 570. In this case, the traffic descriptor of the virtual network group may be an additionally included parameter (optional parameter).

In step 503, the PCF 560 may receive new virtual network related information.

In step 504, the PCF 560 may determine whether to support a plurality of virtual networks using the same DNN based on the received virtual network related information.

In this case, as described above, the PCF 560 should identify whether virtual network traffic supported through the same DNN may be distinguished. In case that a plurality of virtual networks are supported through the same DNN, the PCF 560 may select a representative DNN or may create a new DNN.

In step 504a, when a plurality of virtual network groups are merged into a specific DNN or when a first virtual network group is transmitted, the PCF 560 may determine a case that a specific DNN supports a plurality of virtual network groups. In this case, information whether a plurality of virtual networks have been merged may be stored in the UDM 570 or the UDR 570. A service used in this case may be Nudm_ParameterProvision_update or Nudr_DM_update of the UDM. In case that the virtual network DNN is replaced in step 504, the PCF 560 may store that DNN information of the current virtual network has been replaced or merged by including the replaced DNN. Further, in case that the first virtual network group data has been transmitted to support a plurality of virtual networks in the same DNN, the shared DNN indicator may be stored. Such information may be stored by expanding the virtual network group data.

In step 505, the PCF 560 may create a URSP rule for enabling a UE 530 to support access to a virtual network group. In this case, the URSP may create a URSP rule to support a plurality of virtual networks through the representative DNN determined in step 504. In this case, in case of the UE 530 simultaneously belonging to a plurality of virtual networks, a traffic descriptor and a route selection policy should be configured to create a PDU session with a representative DNN.

In step 506, the PCF 560 may transmit the created URSP rule to the UEs 530 constituting the virtual network. A UE configuration update procedure defined in 3GPP may be used.

In step 507, in order to access a specific virtual network group, the UE 530 may transmit a first message including a PDU session establishment request. The USRP created in step 505 is used, and a DNN supporting a plurality of virtual networks may be selected. Additionally, in case that the UE 530 knows information on the virtual network group to be used at a current time point, a list of identifiers of virtual networks requested by the UE 530 at the current time point may be included in the request together.

In step 508a, an AMF 540 may determine whether the requested DNN accesses the virtual network group through the requested DNN information and subscription data of the UE 530. In this case, in case that the DNNs are merged in step 504, the AMF 540 may identify whether the DNNs are merged based on group information added through step 504a. In order to determine whether the SMF supporting the virtual network group exists, the AMF 540 may use a UECM service of the UDM 570. It is characterized in that an external/internal virtual network group identifier, DNN, S-NSSAI, and the like are additionally included in a Nudm_UECM_get service as a parameter that transmits the UECM to the request.

In step 508, the AMF 540 selects an appropriate SMF with reference to the DNN while receiving and processing the first message including the PDU session establishment request. In case that there is an SMF instance received in step 508a, the AMF 540 selects the SMF instance, and in case that there is no SMF instance, the AMF 540 may select a new SMF. In case of selecting a new SMF instance, by recognizing that a plurality of virtual network groups should be selected, an SMF with a sufficient load level, serving area, and performance should be selected.

In step 509, in order to create a PDU session, the AMF 540 may transmit a second message to an SMF 550. The second message may include a PDUsession_createSMcontext request.

In step 510, the SMF 550 may receive subscription data of the UE 530 that has sent the PDU session establishment request from the UDM 570. In this case, in case that the UE 530 is a member of the virtual network group, virtual network related information may be transmitted together.

In step 511, the SMF 550 may select a PCF for receiving the SM related policy.

In step 512, the SMF 550 may establish SM_policy_assocaition for SM related policy exchange with the PCF 560 selected in step 511.

In step 513, in case that the UE 530 belongs to a plurality of virtual networks, the SMF 550 may create a QoS flow for supporting a plurality of virtual network groups, a QoS rule for supporting this, and a rule for the UPF. Additionally, the SMF 550 may create a mapping relationship between each QoS flow and a virtual network group. In this case, in case that the UE 530 belongs to a plurality of virtual networks, the SMF 550 may create QoS rules and packet processing rules to be performed in the UPF to distinguish each traffic.

In step 514, the SMF 550 may determine whether the corresponding SMF 550 currently manages the virtual network group related PDU session through the merged DNN, and register or update information related to support of a specific virtual network group through a UECM service of UDM so that the corresponding SMF 550 may be selected in case that a PDU session request comes from other UEs in step 508a. In this case, it is characterized in that internal/external virtual network group identifiers, DNNs, and S-NSSAI may be included as transmitted parameters.

In step 515, the SMF 550 may transmit, to the UE 530, information that the PDU session has been established, and in case that a plurality of virtual networks are supported, the SMF 550 may transmit together the mapping relationship between the virtual network group and the QoS flow generated in step 513 and additional QoS rules.

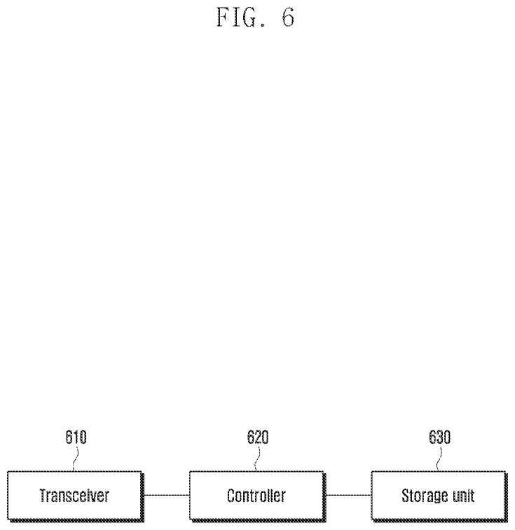

FIG. 6 is a block diagram illustrating a structure of a UE according to an embodiment of the disclosure.

With reference to FIG. 6, the UE may include a transceiver 610, a controller 620, and a storage unit 630. In the disclosure, the controller 620 may be defined as a circuit, an application specific integrated circuit, or at least one processor.

The transceiver 610 may transmit and receive signals to and from other network entities.

The transceiver 610 may receive, for example, system information from a base station, and receive a synchronization signal or a reference signal.

The controller 620 may control the overall operation of the UE according to the embodiment proposed in the disclosure. For example, the controller 620 may control a signal flow between blocks to perform an operation according to the above-described procedure with reference to FIGS. 1 to 5. For example, in order to provide service detection in the mobile communication system according to the embodiment of the disclosure, the controller 620 may control the operation proposed by the disclosure.

The storage unit 630 may store at least one of information transmitted and received through the transceiver 610 or information generated through the controller 620. For example, the storage unit 630 may store information required for service detection according to the above-described embodiment.

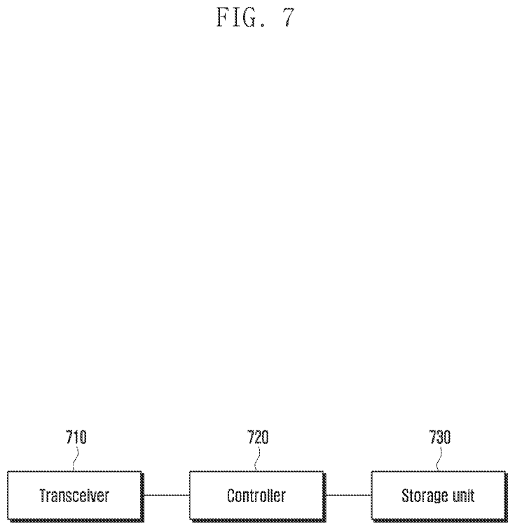

FIG. 7 is a block diagram illustrating a structure of a network entity according to an embodiment of the disclosure. Network entities may include an AMF, SMF, PCF, UDM, UDR, NEF, AF, and the like.

With reference to FIG. 7, the network entity may include a transceiver 710, a controller 720, and a storage unit 730. In the disclosure, the controller 720 may be defined as a circuit, an application specific integrated circuit, or at least one processor.

The transceiver 710 may transmit and receive signals to and from other network entities.

The transceiver 710 may receive, for example, system information from a base station, and receive a synchronization signal or a reference signal.

The controller 720 may control the overall operation of the network entity according to the embodiment proposed in the disclosure. For example, the controller 720 may control a signal flow between blocks to perform an operation according to the above-described procedure with reference to FIGS. 1 to 5. For example, in order to provide service detection in a mobile communication system according to the embodiment of the disclosure, the controller 720 may control an operation proposed by the disclosure.

The storage unit 730 may store at least one of information transmitted and received through the transceiver 710 or information generated through the controller 720. For example, the storage unit 730 may store information required for service detection according to the above-described embodiment.

The foregoing embodiments disclosed in this specification and drawings merely present specific examples in order to easily describe the contents of the disclosure and help the understanding of the disclosure, and they are not intended to limit the scope of the disclosure. Further, one or more of the above-described various embodiments may be combined and performed. Accordingly, all changes or modifications derived based on the disclosure in addition to the embodiments disclosed herein should be construed as being included in the scope of the disclosure.

1. A method performed by a policy control function (PCF) in a wireless communication system, the method comprising:
receiving, from an application function (AF), virtual network related information;
determining whether to support a plurality of virtual networks with the same data network name (DNN) based on the received virtual network related information;
determining, in case that the plurality of virtual networks are supported with the same DNN, a DNN for the plurality of virtual networks;
creating a user route selection policy (URSP) rule for the plurality of virtual networks; and
transmitting, to a terminal, the created URSP rule constituting a virtual network.

2. The method of claim 1, further comprising transmitting, to unified data management (UDM), information on whether a plurality of virtual networks are merged.

3. A method performed by a terminal in a wireless communication system, the method comprising:
receiving, from a policy control function (PCF), a user route selection policy (URSP) rule;
transmitting a first message for a protocol data unit (PDU) session establishment request based on the USRP rule; and
receiving information indicating that a PDU session has been established,
wherein the USRP rule is created by the PCF.

4. The method of claim 3, wherein the information indicating that the PDU session has been established comprises a quality of service (QoS) rule and a QoS flow with a virtual network group, and
the first message further comprises a list of identifiers of the virtual network requested by the terminal.

5. A method performed by an access and mobility management function (AMF) in a wireless communication system, the method comprising:
receiving, from a terminal, a first message for a protocol data unit (PDU) session establishment request based on a user route selection policy (URSP) rule;
selecting a session management function (SMF) based on a data network name (DNN) corresponding to the received first message; and
transmitting, to the selected SMF, a second message for creating a PDU session,
wherein the USRP rule is created by a policy control function (PCF), and
the DNN is determined by the PCF.

6. The method of claim 5, further comprising receiving, from unified data management (UDM), UECM service information for determining whether the SMF exists,
wherein the first message further comprises a list of identifiers of a virtual network requested by the terminal.

7. A method performed by a session management function (SMF) in a wireless communication system, the method comprising:
receiving, from an access and mobility management function (AMF), a second message for creating a PDU session;
receiving, from unified data management (UDM), subscription data of a terminal that has transmitted a first message for a protocol data unit (PDU) session establishment request;
selecting a policy control function (PCF) based on subscription data of the terminal;
exchanging session management (SM) related policies with the selected PCF;
creating, in case that the terminal belongs to a plurality of virtual networks, at least one of a quality of service (QoS) flow, a QoS rule, or a rule for a user plane function (UPF); and
transmitting, to the terminal, information indicating that a PDU session has been established.

8. The method of claim 7, wherein the information indicating that the PDU session has been established comprises the quality of service (QoS) rule and the QoS flow with a virtual network group.

9. A policy control function (PCF) in a wireless communication system, the PCF comprising:
a transceiver configured to transmit and receive at least one signal; and
a controller coupled to the transceiver,
wherein the controller is configured to:
receive, from an application function (AF), virtual network related information,
determine whether to support a plurality of virtual networks with the same data network name (DNN) based on the received virtual network related information;
determine a DNN for the plurality of virtual networks in case that the plurality of virtual networks are supported with the same DNN,
create a user route selection policy (URSP) rule for the plurality of virtual networks, and
transmit, to a terminal, the created URSP rule constituting a virtual network.

10. The PCF of claim 9, wherein the controller is further configured to transmit, to unified data management (UDM), information on whether a plurality of virtual networks are merged.

11. A terminal in a wireless communication system, the terminal comprising:
a transceiver configured to transmit and receive at least one signal; and
a controller coupled to the transceiver,
wherein the controller is configured to:
receive, from a policy control function (PCF), a user route selection policy (URSP) rule,
transmit a first message for a protocol data unit (PDU) session establishment request based on the USRP rule, and
receive information indicating that a PDU session has been established, and
wherein the USRP rule is created by the PCF.

12. The terminal of claim 11, wherein the information indicating that the PDU session has been established comprises a quality of service (QoS) rule and a QoS flow with a virtual network group, and
the first message further comprises a list of identifiers of the virtual network requested by the terminal.

13. An access and mobility management function (AMF) in a wireless communication system, the AMF comprising:
a transceiver configured to transmit and receive at least one signal; and
a controller coupled to the transceiver,
wherein the controller is configured to:
receive, from a terminal, a first message for a protocol data unit (PDU) session establishment request based on a user route selection policy (URSP) rule,
select an SMF based on a data network name (DNN) corresponding to the received first message, and
transmit, to the selected session management function (SMF), a second message for creating a PDU session,
wherein the USRP rule is created by a policy control function (PCF), and the DNN is determined by the PCF.

14. The AMF of claim 13, wherein the controller is further configured to receive, from unified data management (UDM), UECM service information for determining whether the SMF exists,
the first message further comprises a list of identifiers of the virtual network requested by the terminal.

15. A session management function (SMF) in a wireless communication system, the SMF comprising:
a transceiver configured to transmit and receive at least one signal; and
a controller coupled to the transceiver,
wherein the controller is configured to:
receive, from an access and mobility management function (AMF), a second message for creating a PDU session,
receive, from unified data management (UDM), subscription data of a terminal that has transmitted a first message for a protocol data unit (PDU) session establishment request,
select a policy control function (PCF) based on the subscription data of the terminal,
exchange session management (SM) related policies with the selected PCF,
create at least one of a quality of service (QoS) flow, a QoS rule, or a rule for a user plane function (UPF) in case that the terminal belongs to a plurality of virtual networks, and
transmit, to the terminal, information indicating that a PDU session has been established.
